(19) United States
(12) Patent Application Publication
(10) Pub. No.: US 2014/0195226 A1
(43) Pub. Date: Jul. 10, 2014

(54) METHOD AND APPARATUS FOR CORRECTING ERROR IN SPEECH RECOGNITION SYSTEM

(71) Applicant: Electronics and Telecommunications Research Institute, Daejeon-si (KR)

(72) Inventors: Seung YUN, Daejeon-si (KR); Sanghun KIM, Daejeon-si (KR); Jeong Se KIM, Daejeon-si (KR); Soo-jong LEE, Daejeon-si (KR); Ki Hyun KIM, Daejeon-si (KR)

(73) Assignee: Electronics and Telecommunications Research Institute, Daejeon-si (KR)

(21) Appl. No.: 13/902,057

(22) Filed: May 24, 2013

(30) Foreign Application Priority Data
Jan. 4, 2013 (KR) 10-2013-0001202

(51) Int. Cl. G10L 15/01

(52) U.S. Cl. CPC G10L 15/01
USPC 704/231

(57) ABSTRACT

A method of correcting errors in a speech recognition system includes a process of searching a speech recognition error-answer pair DB based on a sound model for a first candidate answer group for a speech recognition error, a process of searching a word relationship information DB for a second candidate answer group for the speech recognition error, a process of searching a user error correction information DB for a third candidate answer group for the speech recognition error, a process of searching a domain articulation pattern DB and a proper noun DB for a fourth candidate answer group for the speech recognition error, and a process of aligning candidate answers within each of the retrieved candidate answer groups and displaying the aligned candidate answers.

### RELATED APPLICATIONS(S)

This application claims the benefit of Korean Patent Application No. 10-2013-0001202, filed on Jan. 4, 2013, which is hereby incorporated by references as if fully set forth herein.

### FIELD OF THE INVENTION

The present invention relates to a scheme for correcting errors in speech recognition, and more particularly, to a method and apparatus for correcting errors in a speech recognition system, which is suitable for effectively providing candidate answers for a corresponding erroneous word using various types of search DBs when an error occurs during the process of speech recognition by the speech recognition system.

### BACKGROUND OF THE INVENTION

In general, current speech recognition schemes applied to speech recognition systems inevitably give rise to recognition errors because they are not technically perfect. Furthermore, existing voice recognizers do not propose candidate answers for such speech recognition errors. Although existing voice recognizers propose candidate answers, they are problematic in that the accuracy of the proposed candidate answers is low because the existing voice recognizers propose n-best or lattice candidates that have a high possibility of being the answer in the decoding process of the voice recognizers.

Furthermore, the existing method is problematic in that it has insufficient technique for compensating for the disadvantages of a sound model, and the existing continuous speech voice recognizer is fundamentally limited due to the adoption of a language model based on n-gram.

In particular, as the number of smart phone users is increasing, voice recognizers do not incorporate the realities of use by various types of users in various fields. That is, the existing method is problematic in that user error correction information and domain information, which can contribute to the improvement of speech recognition performance, are not sufficiently utilized.

### SUMMARY OF THE INVENTION

In view of the above, the present invention provides an error detection scheme capable of effectively handling speech recognition errors, which inevitably occur in a voice recognizer, using a variety of pieces of DB information.

Furthermore, the present invention provides an error detection scheme capable of enhancing user convenience and easily obtaining more correct speech recognition results by proposing candidate answers for an erroneous word using a speech recognition ‘error-answer’ pair DB based on a sound model, a word relationship information DB, a user error correction information DB, a domain articulation pattern DB, and a proper noun DB.

In accordance with an aspect of the present invention, there is provided a method of correcting errors in a speech recognition system, including a process of searching a speech recognition error-answer pair DB based on a sound model for a first candidate answer group for a speech recognition error, a process of searching a word relationship information DB for a second candidate answer group for the speech recognition error, a process of searching a user error correction information DB for a third candidate answer group for the speech recognition error, a process of searching a domain articulation pattern DB and a proper noun DB for a fourth candidate answer group for the speech recognition error, and a process of aligning candidate answers within each of the retrieved candidate answer groups and displaying the aligned candidate answers.

The process of displaying the aligned candidate answers may include displaying a candidate answer that belongs to one or more of the retrieved candidate answer groups as a final candidate answer.

The process of displaying the aligned candidate answers may include displaying only a candidate answer that belongs to all of the retrieved candidate answer groups as a final candidate answer.

The process of displaying the aligned candidate answers may include aligning the retrieved candidate answer groups according to specific priority and displaying the aligned candidate answer groups.

The process of searching for the first candidate answer group may include a process of searching the speech recognition error-answer pair DB for a candidate answer group, a process of calculating phonetic similarity for a corresponding speech recognition erroneous word and extracting a word having relatively high phonetic similarity from among words included in a recognition dictionary as a preliminary candidate answer group if, as a result of the search, no candidate answer group exists, and a process of setting the candidate answer group or the preliminary candidate answer group as the first candidate answer group.

The phonetic similarity may be calculated by calculating the distance between phonemes.

The process of searching for the first candidate answer group may further include a process of adjusting the number of candidate answers that belong to the determined first candidate answer group to a specific number if the number of candidate answers is plural.

The process of searching for the second candidate answer group may include a process of extracting the remaining words, other than a word recognized as the speech recognition error, a process of extracting candidate words having a semantic correlation between words by searching the word relationship information DB based on the extracted words, and a process of setting a word common to the extracted candidate words as the second candidate answer group.

The process of searching for the second candidate answer group may further include a process of adjusting the number of candidate answers that belong to the determined second candidate answer group to a specific number if the number of candidate answers is plural.

The adjustment to the specific number is limited to a word having relatively high phonetic similarity.

The process of searching for the third candidate answer group may include a process of searching the user error correction information DB for a candidate answer group for a corresponding erroneous word, a process of checking the number of candidate answers within the retrieved candidate answer group, searching a server-based user error correction information DB for a preliminary candidate answer group if, as a result of the check, the number of candidate answers is less than a specific number, and setting the candidate answer group or both the candidate answer group and the preliminary candidate answer group as the third candidate answer group.

The process of searching for the third candidate answer group may further include a process of adjusting the number of candidate answers that belong to the determined third candidate answer group to the specific number if the number of candidate answers is plural.

The adjustment to the specific number is performed based on any one of phonetic similarity, information on correlation between words, and information on a domain pattern.

The process of searching for the preliminary candidate answer group may be selectively executed when a voice recognizer is a recognizer adopting a server-client method.

The process of searching for the fourth candidate answer group may include a process of checking whether or not a corresponding erroneous word belongs to articulation to which a domain articulation pattern is applied by searching the domain articulation pattern DB, a process of extracting a candidate answer group by searching the proper noun DB if, as a result of the check, the corresponding erroneous word belongs to the domain articulation pattern, and a process of setting the extracted candidate answer group as the fourth candidate answer group.

The process of searching for the fourth candidate answer group may further include a process of adjusting the number of candidate answers that belong to the determined fourth candidate answer group to a specific number if the number of candidate answers is plural.

The adjustment to the specific number is limited to a word having relatively high phonetic similarity.

In accordance with another aspect of the present invention, there is provided an apparatus for correcting errors in a speech recognition system, including a database module for including a speech recognition error-answer pair DB based on a sound model, a word relationship information DB, a user error correction information DB, a domain articulation pattern DB, and a proper noun DB, a speech recognition error detection block for detecting errors in speech recognition for input speech, a first candidate answer search block for determining a first candidate answer group for a corresponding erroneous word using the speech recognition error-answer pair DB when the error in speech recognition is detected, a second candidate answer search block for determining a second candidate answer group for the corresponding erroneous word using the word relationship information DB when the error in speech recognition is detected, a third candidate answer search block for determining a third candidate answer group for the corresponding erroneous word using the user error correction information DB when the error in speech recognition is detected, a fourth candidate answer search block for determining a fourth candidate answer group for the corresponding erroneous word using the domain articulation pattern DB and the proper noun DB when the error in speech recognition is detected, and a candidate answer alignment and display block for aligning candidate answers within each of the determined candidate answer groups according to a specific condition and displaying the aligned candidate answers.

The candidate answer alignment and display block may display a candidate answer that belong to one or more of the determined candidate answer groups as a final candidate answer.

The candidate answer alignment and display block may determine only a candidate answer that belongs to all of the determined candidate answer groups as a final candidate answer and display the determined final candidate answer.

### BRIEF DESCRIPTION OF THE DRAWINGS

The above and other objects and features of the present invention will become apparent from the following description of embodiments given in conjunction with the accompanying drawings, in which:

FIG. 1 is a block diagram of an error correction apparatus in a speech recognition system in accordance with an embodiment of the present invention;

FIG. 2 is a detailed block diagram of a first candidate answer search block shown in FIG. 1;

FIG. 3 is a detailed block diagram of a second candidate answer search block shown in FIG. 1;

FIG. 4 is a detailed block diagram of a third candidate answer search block shown in FIG. 1;

FIG. 5 is a detailed block diagram of a fourth candidate answer search block shown in FIG. 1;

FIG. 6 is a flowchart illustrating major processes of the speech recognition system performing error correction in accordance with an embodiment of the present invention;

FIG. 7 is a flowchart illustrating major processes of determining candidate answers using a speech recognition error-answer pair DB in accordance with the present invention;

FIG. 8 is a flowchart illustrating major processes of determining candidate answers using a word relationship information DB in accordance with the present invention;

FIG. 9 is a flowchart illustrating major processes of determining candidate answers using a user error correction information DB in accordance with the present invention; and

FIG. 10 is a flowchart illustrating major processes of determining candidate answers using a domain articulation pattern DB and a proper noun DB in accordance with the present invention.

### DETAILED DESCRIPTION OF THE EMBODIMENTS

Hereinafter, embodiments of the present invention will be described in detail with reference to the accompanying drawings which form a part hereof.

First, the merits and characteristics of the present invention and the methods for achieving the merits and characteristics thereof will become more apparent from the following embodiments taken in conjunction with the accompanying drawings. However, the present invention is not limited to the disclosed embodiments, but may be implemented in various ways. The embodiments are provided to complete the disclosure of the present invention and to enable a person having ordinary skill in the art to understand the scope of the present invention. The present invention is defined by the category of the claims.

In describing the embodiments of the present invention, a detailed description of known functions or constructions related to the present invention will be omitted if it is deemed that they would make the gist of the present invention unnecessarily vague. Furthermore, terms to be described later are defined by taking functions in embodiments of the present invention into consideration, and may be different according to the operator's intention or usage. Accordingly, the terms should be defined based on the contents of the specification.

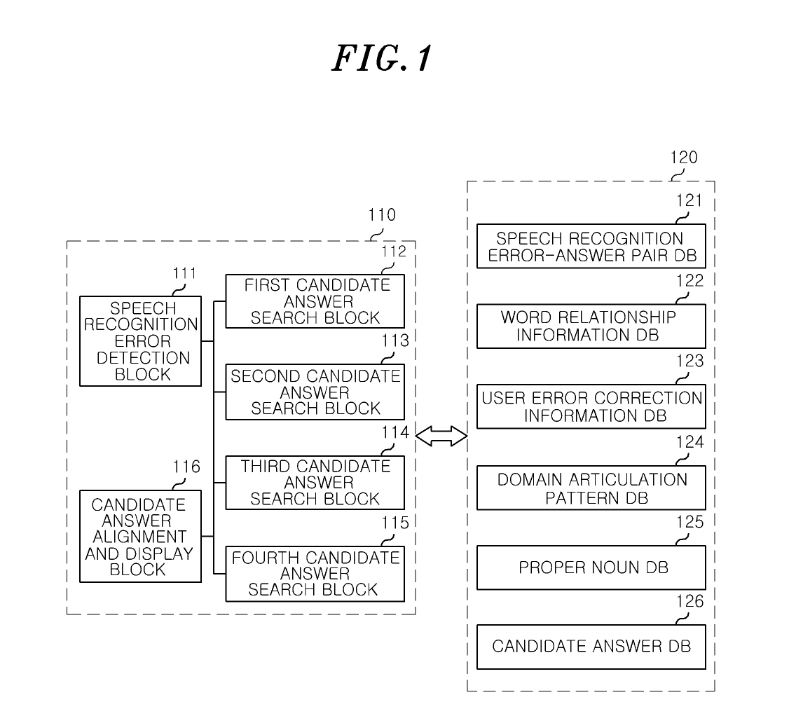

FIG. 1 is a block diagram of an error correction apparatus in a speech recognition system in accordance with an embodiment of the present invention. The error correction apparatus may basically include a speech recognition error correction module 110 and a database module 120.

Referring to FIG. 1, the speech recognition error correction module 110 can include a speech recognition error detection block 111, a first candidate answer search block 112, a second candidate answer search block 113, a third candidate answer search block 114, a fourth candidate answer search block 115, and a candidate answer alignment and display block 116. The database module 120 can include a speech recognition error-answer pair DB 121, a word relationship information DB 122, a user error correction information DB 123, a domain articulation pattern DB 124, a proper noun DB 125, and a candidate answer DB 126.

First, the speech recognition error detection block 111 of the speech recognition error correction module 110 can provide a function of detecting an error of speech recognition for input speech using a known error recognition scheme. Here, information on the detected error for speech recognition (hereinafter referred to as ‘speech recognition error information’) can be transferred to any one of the first through the fourth candidate answer search blocks 112 to 115.

When the speech recognition error information is received from the speech recognition error detection block 111 (i.e., when a speech recognition error is detected), the first candidate answer search block 112 can provide a function of determining (or searching for) a first candidate answer group for a corresponding erroneous word using the speech recognition error-answer pair DB 121 of the database module 120 and storing the determined first candidate answer group in the candidate answer DB 126. The first candidate answer group can include one or a plurality of candidate answers.

Here, a sound model adopted by a voice recognizer is trained by a speech DB, and the trained sound model is absolutely influenced by the characteristics of the speech DB used in the training. In this process, if a specific phoneme or phoneme chain within the speech DB used in the training has abnormal statistics, there is a high probability that a word including the specific phoneme or phoneme chain may be recognized in error. As a result, the performance of speech recognition may be deteriorated.

In order to compensate for this problem, in the present invention, a speech DB used in the training of a sound model is prepared, and speech recognition is attempted by inputting a sound model produced using the speech DB as an input to a voice recognizer.

If an error occurs in the speech DB used in the sound model training through this speech recognition, the error corresponds to the weak point of the voice recognizer due to the insufficiency or imbalance of the sound model other than portions affected by a language model. In the present invention, error-answer pairs are stored in the speech recognition error-answer pair DB 121, and the stored error-answer pairs are used to search for candidate answers.

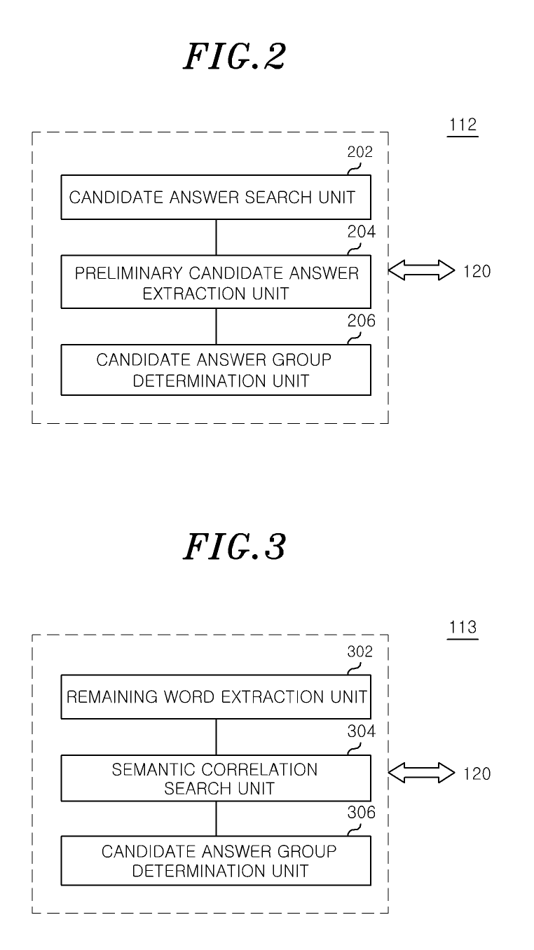

FIG. 2 is a detailed block diagram of the first candidate answer search block 112 shown in FIG. 1. The first candidate answer search block 112 may include a candidate answer search unit 202, a preliminary candidate answer extraction unit 204, and a candidate answer group determination unit 206.

Referring to FIG. 2, when a speech recognition error is detected, the candidate answer search unit 202 can provide a function of searching the speech recognition error-answer pair DB 121 for a candidate answer group. The retrieved candidate answer group can include one or a plurality of candidate answers, and the retrieved candidate answer group is stored in the candidate answer DB 126.

If, as a result of the search by the candidate answer search block 202, a candidate answer group is not present, the preliminary candidate answer extraction unit 204 can provide a function of calculating the phonetic similarity of an erroneous word (i.e., an erroneous speech recognition word) and extracting a word having relatively high phonetic similarity, from among words included in a recognition dictionary, as a preliminary candidate answer group. The extracted preliminary candidate answer group can include one or a plurality of preliminary candidate answers, and the extracted preliminary candidate answer group is stored in the candidate answer DB 126.

Furthermore, the candidate answer group determination unit 206 can provide a function of setting the candidate answer group or the preliminary candidate answer group stored in the candidate answer DB 126 as the first candidate answer group. Here, phonetic similarity can be calculated by measuring the distance between phonemes. If the number of candidate answers belonging to the determined first candidate answer group is plural, the number of candidate answers can be adjusted to a specific number. The first candidate answer group determined as described above is stored in the candidate answer DB 126.

Referring back to FIG. 1, when the speech recognition error information is received from the speech recognition error detection block 111 (i.e., when the speech recognition error is detected), the second candidate answer search block 113 can provide a function of determining (searching for) a second candidate answer group for the corresponding erroneous word using the word relationship information DB 122 of the database module 120 and storing the determined second candidate answer group in the candidate answer DB 126. The second candidate answer group can include one or a plurality of candidate answers.

Here, a language model is essentially adopted in a voice recognizer. Most continuous speech voice recognizers train their language models based on n-gram from corpora. The voice recognizers produced as described above are absolutely influenced by the constructed n-gram statistical information. However, long-distance dependence is not incorporated into the n-gram statistical information, but only relationships between short distances are incorporated into the n-gram statistical information. Accordingly, there is a limit whereby the entire semantic correlation of recognized articulation is indirectly incorporated into the n-gram statistical information.

In order to overcome this limit, in the present invention, corpora constructed to train a language model are prepared, a semantic correlation between words, such as co-occurrence information, is calculated by the sentence from a corresponding corpus, meaningful word pairs are stored (constructed) in the word relationship information DB 122, and the stored meaningful word pairs are used to search for candidate answers.

FIG. 3 is a detailed block diagram of the second candidate answer search block 113 shown in FIG. 1. The second candidate answer search block 113 may include a remaining word extraction unit 302, a semantic correlation search unit 304, and a candidate answer group determination unit 306.

Referring to FIG. 3, when a speech recognition error is detected, the remaining word extraction unit 302 can provide a function of extracting the remaining words other than a recognized erroneous word. The extracted remaining words are transferred to the semantic correlation search unit 304.

The semantic correlation search unit 304 can provide a function of searching the word relationship information DB 122 based on the remaining words extracted by the remaining word extraction unit 302 and extracting candidate words, having a semantic correlation between words, from the retrieved words.

The candidate answer group determination unit 306 can provide a function of setting a word common to the candidate words, extracted by the semantic correlation extraction unit 304, as the second candidate answer group. If the number of candidate answers belonging to the determined second candidate answer group is plural, the number of candidate answers can be adjusted to a specific number (i.e., the candidate answer is limited to a word having relatively high phonetic similarity) based on phonetic similarity. The second candidate answer group determined as described above is stored in the candidate answer DB 126.

For example, if a user spoke the sentence, for example, ‘I ate a meal’, but the sentence was recognized as ‘I ate a bar’, when the user selects ‘a meal’, co-occurring words for the remaining ‘I’ and ‘ate’ are searched for and then candidates (e.g., rice, bread, ramen, and a drink) having a correlation with ‘I’ and ‘ate’ are suggested as candidate answers. Here, if the number of remaining words is high, words having a partial semantic correlation with some words can be recognized as candidate answers. Furthermore, information on postpositions, auxiliary predicates, and the endings of words may also be used depending on how the correlation is calculated.

Furthermore, if the number of candidate answers having correlations therebetween is high, the number of candidate answers including words having high phonetic similarity may be limited to a set number and suggested.

Referring back to FIG. 1, when the speech recognition error information is received from the speech recognition error detection block 111 (i.e., when the speech recognition error is detected), the third candidate answer search block 114 can provide a function of determining (searching for) a third candidate answer group for the corresponding erroneous word using the user error correction information DB 123 of the database module 120 and storing the determined third candidate answer group in the candidate answer DB 126. The third candidate answer group can include one or a plurality of candidate answers.

Recently, most voice recognizers adopt a speaker-independent speech recognition method, whereas some voice recognizers adopt a speaker-adaptive scheme, but the actual improvement in performance thereof is slight. For this reason, if an error occurs once in relation to a word spoken by a user, the same error continues to occur for the word.

In the present invention, in order to compensate for this problem, an error correction tool using text input is provided to the user interface of a voice recognizer. If a user corrects an error using the error correction tool, information on the corrected error is stored in the user error correction information DB 123 as an error-answer pair and the stored error-answer pair is used to search for candidate answers. Furthermore, if a voice recognizer adopts a server-client method, the error-answer pair may be sent to a server so that it can be used by other users.

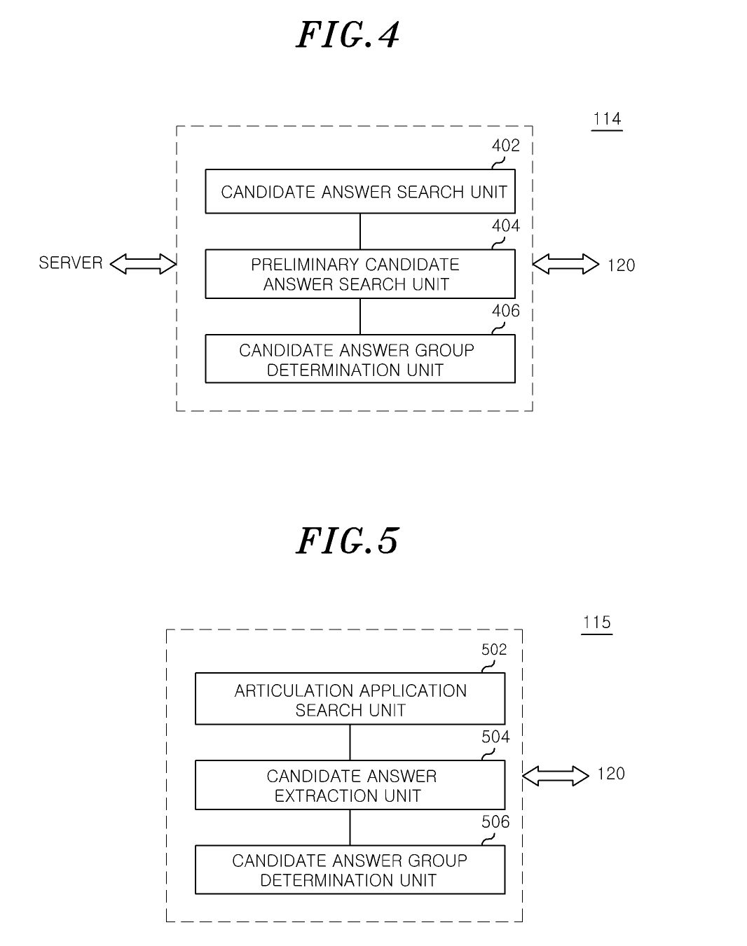

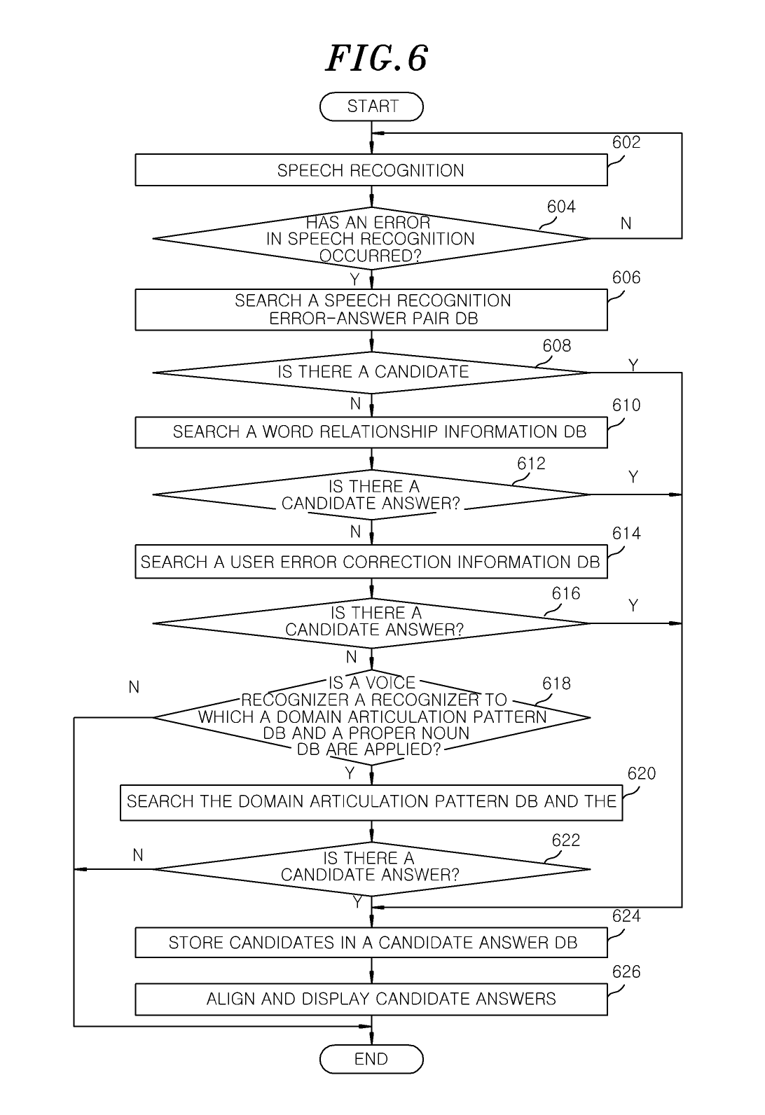

FIG. 4 is a detailed block diagram of the third candidate answer search block 114 shown in FIG. 1. The third candidate answer search block 114 may include a candidate answer search unit 402, a preliminary candidate answer search unit 404, and a candidate answer group determination unit 406.

Referring to FIG. 4, when a speech recognition error is detected, the candidate answer search unit 402 can provide a function of searching the user error correction information DB 123 for a candidate answer group. The retrieved candidate answer group can include one or a plurality of candidate answers, and the retrieved candidate answer group is stored in the candidate answer DB 126.

The preliminary candidate answer extraction unit 404 can provide a function of checking whether or not a candidate answer group is present or whether or not the number of retrieved candidate answer groups is smaller than a specific number as a result of the search by the candidate answer search block 402. If, as a result of the check, no candidate answer group is present or the number of retrieved candidate answer groups is smaller than the specific number and a voice recognizer adopts a server-client method, the preliminary candidate answer extraction unit 404 can provide a function of searching server-based user error correction information DBs (i.e., others' user error correction information DBs) for candidate answer groups and extracting a preliminary candidate answer group from the retrieved candidate answer groups. The extracted preliminary candidate answer group can include one or a plurality of preliminary candidate answers, and the extracted preliminary candidate answer group is stored in the candidate answer DB 126.

The candidate answer group determination unit 406 can provide a function of setting the candidate answer group or both the candidate answer group and the preliminary candidate answer group, stored in the candidate answer DB 126, as the third candidate answer group. If the number of candidate answers belonging to the determined third candidate answer group is plural, the number of candidate answers can be adjusted to a specific number based on any one of phonetic similarity, information on a correlation between words, and information on a domain pattern. The third candidate answer group determined as described above is stored in the candidate answer DB 126.

Referring back to FIG. 1, when the speech recognition error information is received from the speech recognition error detection block 111, that is, when the speech recognition error is detected, the fourth candidate answer search block 115 can provide a function of checking whether or not a voice recognizer is a voice recognizer to which the domain articulation pattern DB 124 and the proper noun DB 125 have been applied, determining (searching for) the fourth candidate answer group for a corresponding erroneous word using the domain articulation pattern DB 124 and the proper noun DB 125 of the database module 120 if, as a result of the check, the voice recognizer is a voice recognizer to which the domain articulation pattern DB 124 and the proper noun DB 125 have been applied, and storing the determined fourth candidate answer group in the candidate answer DB 126. The fourth candidate answer group can include one or a plurality of candidate answers.

Here, vocabulary may not be registered because a voice recognizer cannot recognize all words. This becomes a cause of a speech recognition error.

In the present invention, in order to handle this recognition error, a proper noun DB is constructed for the domain, for example, a domain is set as a corresponding area if the domain is a recognizer specialized for each area, and a Point-of-Interest (POI) name indicative of the corresponding area is stored in the proper noun DB. Next, a domain articulation pattern indicative of the constructed proper noun DB is stored in a database and used to search for candidate answers.

For example, ‘UCLA’, ‘Hollywood’, ‘Disneyland’, or ‘Long Beach’ can become a POI name proper noun DB, and a domain articulation pattern indicative of a corresponding proper noun DB can be, for example, ‘How do I get to ˜?’, ‘Where is ˜?’, and ‘How long does it take to ˜?’. Here, a proper noun can be realized in various forms (e.g., a name of a food, a person's name, and a product name) depending on how a corresponding domain is set.

FIG. 5 is a detailed block diagram of the fourth candidate answer search block 115 shown in FIG. 1. The fourth candidate answer search block 115 may include an articulation application search unit 502, a candidate answer extraction unit 504, and a candidate answer group determination unit 506.

Referring to FIG. 5, when a speech recognition error is detected, the articulation application search unit 502 can provide a function of searching a speech recognition erroneous word for the domain articulation pattern DB 124 and determining whether or not the speech recognition erroneous word belongs to articulation to which a domain articulation pattern is applied based on the search result. The retrieved articulation application result is transferred to the candidate answer extraction unit 504.

When a result indicating that the speech recognition erroneous word is determined to belong to the domain articulation pattern is received from the articulation application search unit 502, the candidate answer extraction unit 504 can provide a function of extracting a candidate answer group by searching the proper noun DB 125. The extracted candidate answer group can include one or a plurality of candidate answers, and the extracted candidate answer group is stored in the candidate answer DB 126.

The candidate answer group determination unit 506 can provide a function of setting the candidate answer group extracted by the candidate answer extraction unit 504 as the fourth candidate answer group. If the number of candidate answers belonging to the determined fourth candidate answer group is plural, the number of candidate answers can be adjusted to a specific number based on phonetic similarity (i.e., the candidate answer can be limited to words having relatively high phonetic similarity). The fourth candidate answer group determined as described above is stored in the candidate answer DB 126. Here, domain information may be combined with user information and used.

Referring back to FIG. 1, the candidate answer alignment and display block 116 can provide a function of aligning candidate answers within the candidate answer groups (i.e., the first to the fourth candidate answer groups), determined by the first to the fourth candidate answer search blocks 112 to 115, according to a specific condition and displaying the aligned candidate answers. For example, the candidate answer alignment and display block 116 can align and display a candidate answer belonging to one or more of the determined candidate answer groups as the final candidate answer, determine and display only a candidate answer that belongs to all of the determined candidate answer groups as the final candidate answer, and align and display the determined candidate answer groups according to some specific priority.

A series of processes of providing error correction service by utilizing various types of DBs when a speech recognition error is detected using the error correction apparatus constructed above are described below.

FIG. 6 is a flowchart illustrating major processes of the speech recognition system performing error correction in accordance with an embodiment of the present invention.

Referring to FIG. 6, the speech recognition error detection block 111 determines whether or not an error of speech recognition for input speech has occurred at step 604 when executing speech recognition mode at step 602.

If, as a result of the check at step 604, a speech recognition error is determined to have occurred, the first candidate answer search block 112 searches the speech recognition error-answer pair DB 121 of the database module 120 for a first candidate answer group at steps 606 and 608. If, as a result of the search, the first candidate answer group is present, the first candidate answer search block 112 extracts candidate answers from the retrieved first candidate answer group and stores the extracted candidate answers in the candidate answer DB 126 at step 624. Here, the retrieved first candidate answer group can include one or a plurality of candidate answers.

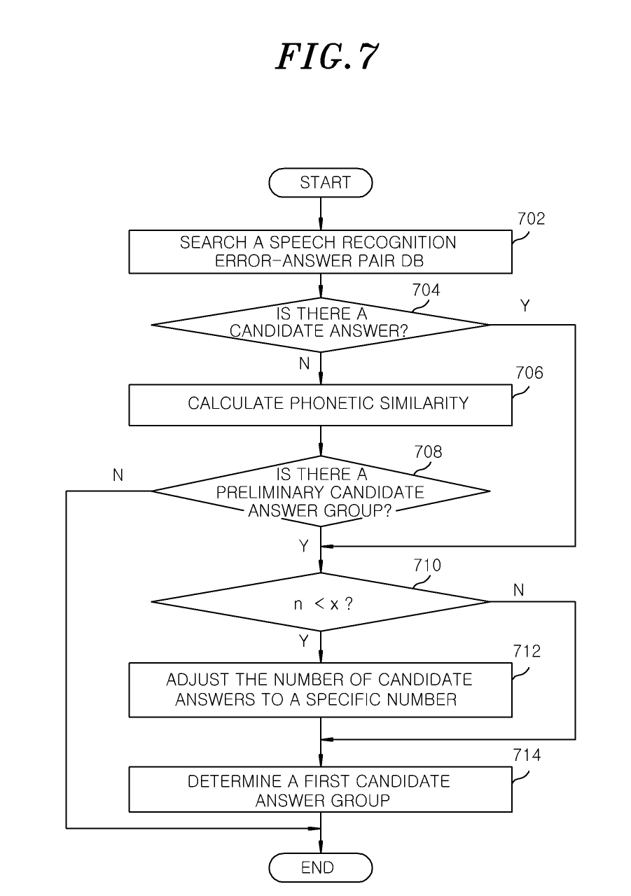

FIG. 7 is a flowchart illustrating major processes (steps 606 and 608) of determining candidate answers using the speech recognition error-answer pair DB 121 in accordance with the present invention.

Referring to FIG. 7, when a speech recognition error is detected, the candidate answer search unit 202 of FIG. 2 checks whether or not a candidate answer group is present (step 704) by searching the speech recognition error-answer pair DB 121 at step 702. If, as a result of the check at step 704, a candidate answer group is present, the process proceeds to step 710, to be described later.

If, as a result of the check at step 704, no candidate answer group is present, the preliminary candidate answer extraction unit 204 calculates phonetic similarity for an erroneous word (i.e., an erroneous speech recognition word) at step 706 and extracts a word having relatively high phonetic similarity, from among words included in a recognition dictionary, as a preliminary candidate answer group (that is, searches for the preliminary candidate answer group) based on the calculated phonetic similarity at step 708.

Next, the candidate answer group determination unit 206 checks whether or not the number of candidate answers ‘n’ within the candidate answer group or the preliminary candidate answer group is less than a specific number ‘x’ at step 710. If, as a result of the check at step 206, ‘n’ is less than ‘x’, the candidate answers are set as the first candidate answer group at step 714. Next, the process proceeds to step 624 of FIG. 6, and the determined first candidate answer group is stored in the candidate answer DB 126.

If, as a result of the check at step 710, ‘n’ is not less than ‘x’, the candidate answer group determination unit 206 adjusts the number of candidate answers ‘n’ to the specific number ‘x’ based on, for example, phonetic similarity calculated by measuring the distance between phonemes at step 712. The candidate answers adjusted as described above are set as the first candidate answer group at step 714. Next, the process proceeds to step 624 of FIG. 6, and the determined first candidate answer group is stored in the candidate answer DB 126.

Referring back to FIG. 6, when a speech recognition error is detected, the second candidate answer search block 113 checks whether or not a second candidate answer group is present (step 612) by searching the word relationship information DB 122 of the database module 120 at step 610.

If, as a result of the check at step 612, a second candidate answer group is present, the word relationship information DB 122 extracts candidate answers from the retrieved second candidate answer group and stores the extracted candidate answers in the candidate answer DB 126 at step 624. Here, the retrieved second candidate answer group can include one or a plurality of candidate answers.

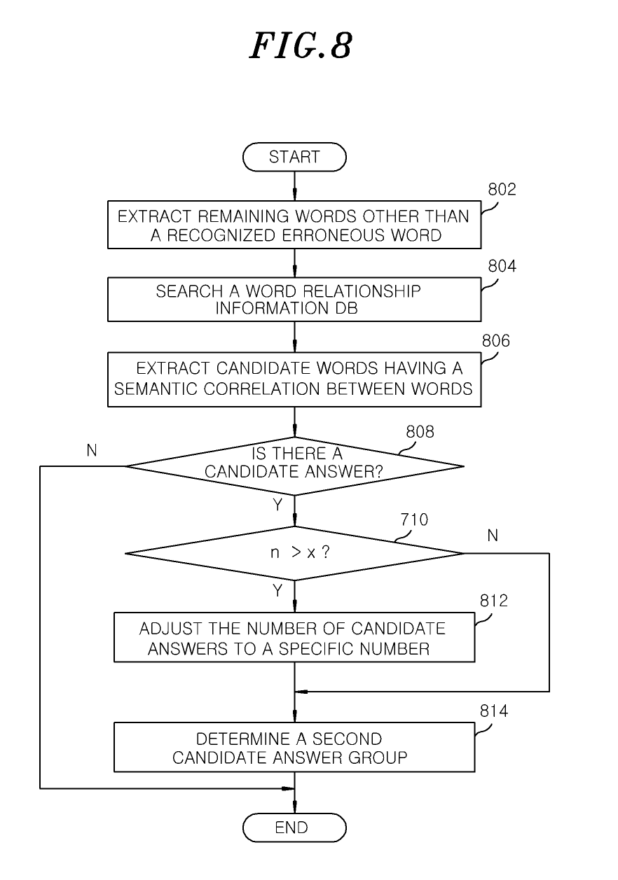

FIG. 8 is a flowchart illustrating major processes (steps 610 and 612) of determining candidate answers using the word relationship information DB 122 in accordance with the present invention.

Referring to FIG. 8, when a speech recognition error is detected, the remaining word extraction unit 302 of FIG. 3 extracts the remaining words other than the recognized erroneous word at step 802. The semantic correlation search unit 304 searches the word relationship information DB 122 based on the extracted words at step 804 and extracts candidate words having a semantic correlation between words from the retrieved words at step 806.

Next, the candidate answer group determination unit 306 determines a common word within each of the candidate words, extracted by the semantic correlation extraction unit 304, as a second candidate answer group, that is, checks whether or not a candidate answer group is present at step 808. Here, the determined second candidate answer group can include one or a plurality of candidate answers.

Furthermore, the candidate answer group determination unit 306 checks whether or not the number of candidate answers ‘n’ within the candidate answer group exceeds a specific number ‘x’ at step 810. If, as a result of the check at step 810, ‘n’ does not exceeds ‘x’, the candidate answers are set as the second candidate answer group at step 814. Next, the process proceeds to step 624 of FIG. 6, and the determined second candidate answer group is stored in the candidate answer DB 126.

If, as a result of the check at step 810, ‘n’ exceeds ‘x’, the candidate answer group determination unit 306 adjusts the number of candidate answers to the specific number ‘x’ based on, for example, phonetic similarity calculated by measuring the distance between phonemes at step 812. The candidate answers adjusted as described above are set as the second candidate answer group at step 814. Next, the process proceeds to step 624 of FIG. 6, and the determined second candidate answer group is stored in the candidate answer DB 126.

Referring back to FIG. 6, when a speech recognition error occurs, the third candidate answer search block 114 checks whether or not a third candidate answer group is present (step 616) by searching the user error correction information DB 123 of the database module 120 at step 614. If, as a result of the check at step 616, the third candidate answer group is present, the third candidate answer search block 114 extracts candidate answers from the retrieved third candidate answer group and stores the extracted candidate answers in the candidate answer DB 126 at step 624. Here, the retrieved third candidate answer group can include one or a plurality of candidate answers.

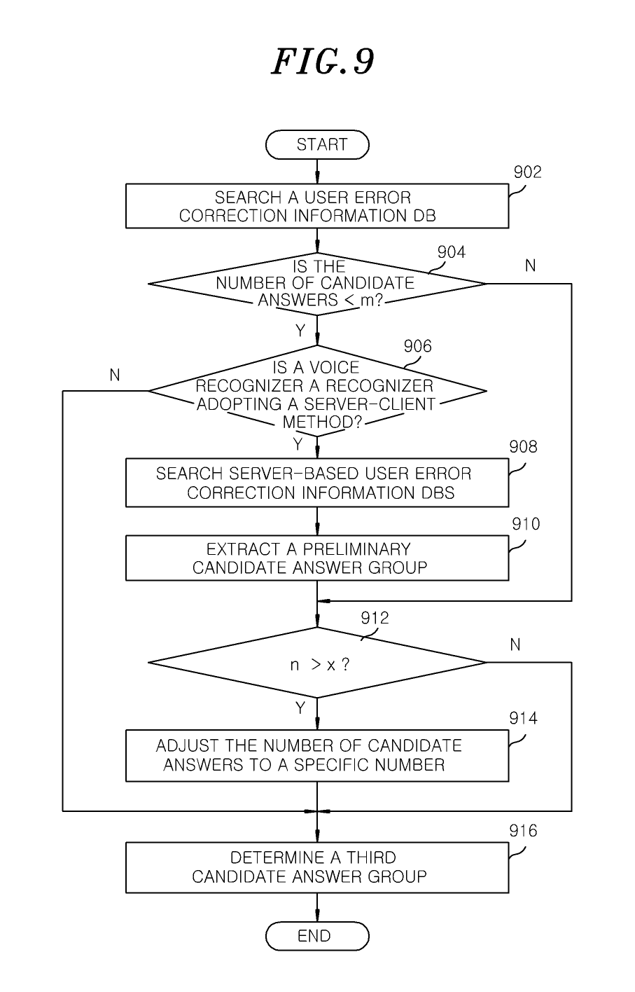

FIG. 9 is a flowchart illustrating major processes (steps 614 and 616) of determining candidate answers using the user error correction information DB 123 in accordance with the present invention.

Referring to FIG. 9, when a speech recognition error is detected, the candidate answer search unit 402 of FIG. 4 searches the user error correction information DB 123 for a candidate answer at step 902. If, as a result of the search, a candidate answer is present, the candidate answer search unit 402 checks whether or not the number of retrieved candidate answers is less than a specific number ‘m’ at step 904. If, as a result of the check at step 904, the number of retrieved candidate answers is not less than the specific number ‘m’, the process proceeds to step 912 to be described later.

If, as a result of the check at step 904, the number of retrieved candidate answers is less than the specific number ‘m’, the candidate answer search unit 402 checks whether or not an applied voice recognizer is a recognizer adopting a server-client method at step 906. If, as a result of the check at step 906, the applied voice recognizer is not a recognizer adopting a server-client method, the process proceeds to step 916, to be described later.

If, as a result of the check at step 906, the applied voice recognizer is a recognizer adopting a server-client method, the preliminary candidate answer search unit 404 extracts a preliminary candidate answer group (step 910) by searching server-based user error correction information DBs (i.e., others' user error correction information DBs) at step 908.

Next, the candidate answer group determination unit 406 checks whether or not the number of candidate answers ‘n’ within the candidate answer group or the preliminary candidate answer group exceeds a specific number ‘x’ at step 912. If, as a result of the check at step 912, ‘n’ does not exceed ‘x’, the candidate answers are set as the third candidate answer group at step 916. Next, the process proceeds to step 624 of FIG. 6, and the determined third candidate answer group is stored in the candidate answer DB 126.

If, as a result of the check at step 912, ‘n’ exceeds ‘x’, the candidate answer group determination unit 406 adjusts the number of candidate answers ‘n’ to the specific number ‘x’ based on any one of, for example, phonetic similarity, information on a correlation between words, and information on a domain pattern at step 914. The candidate answers adjusted as described above are set as the third candidate answer group at step 916. Next, the process proceeds to step 624 of FIG. 6, and the determined third candidate answer group is stored in the candidate answer DB 126.

Referring back to FIG. 6, the fourth candidate answer search block 115 of FIG. 1 determines whether or not a voice recognizer is a recognizer to which the domain articulation pattern DB 124 and the proper noun DB 125 are applied at step 618. If, as a result of the determination at step 618, the voice recognizer is determined not to be a recognizer to which the domain articulation pattern DB 124 and the proper noun DB 125 are applied, the process is terminated.

If, as a result of the determination at step 618, the voice recognizer is determined to be a recognizer to which the domain articulation pattern DB 124 and the proper noun DB 125 are applied, the fourth candidate answer search block 115 checks whether or not a fourth candidate answer group is present (step 622) by searching the domain articulation pattern DB 124 and the proper noun DB 125 at step 620. If, as a result of the check at step 622, a fourth candidate answer group is present, the fourth candidate answer search block 115 extracts candidate answers from the fourth candidate answer group and stores the extracted candidate answers in the candidate answer DB 126 at step 624. Here, the retrieved fourth candidate answer group can include one or a plurality of candidate answers.

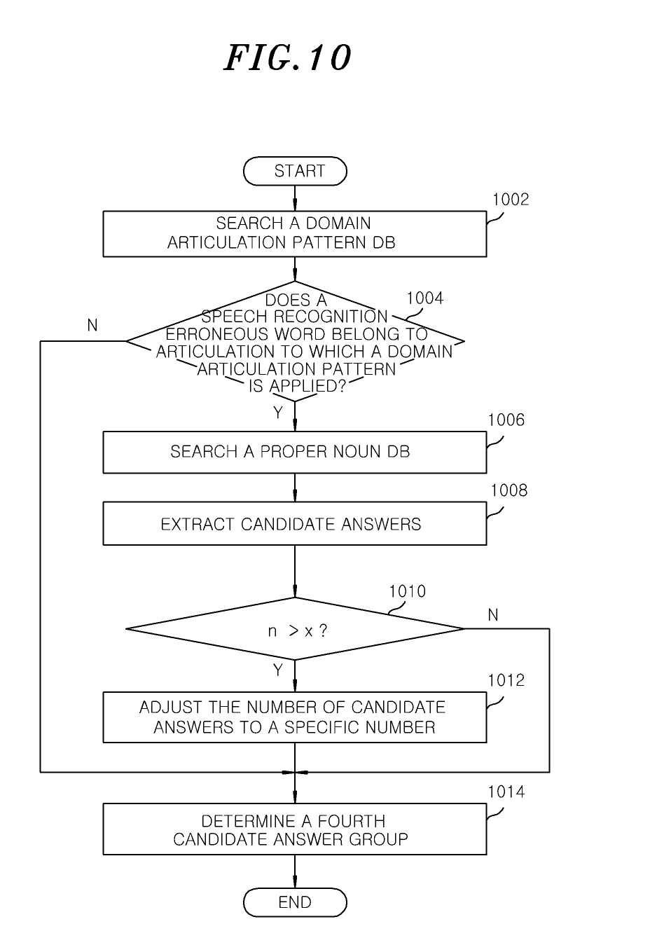

FIG. 10 is a flowchart illustrating major processes (steps 620 and 622) of determining candidate answers using the domain articulation pattern DB 124 and the proper noun DB 125 in accordance with the present invention.

Referring to FIG. 10, the articulation application search unit 502 of FIG. 5 searches the domain articulation pattern DB 124 at step 1002 and checks whether or not an erroneous speech recognition word belongs to articulation to which a domain articulation pattern is applied based on a result of the search at step 1004.

If, as a result of the check at step 1004, the speech recognition erroneous word belongs to articulation to which a domain articulation pattern is applied, the candidate answer extraction unit 504 searches the proper noun DB 125 for a candidate answer group at step 1006 and extracts one or more candidate answers from the retrieved candidate answer group at step 1008.

Next, the candidate answer group determination unit 506 checks whether or not the number of extracted candidate answers ‘n’ exceeds a specific number ‘x’ at step 1010. If, as a result of the check at step 1010, ‘n’ does not exceed ‘x’, the extracted candidate answers are determined as the fourth candidate answer group at step 1014. Next, the process proceeds to step 624 of FIG. 6, and the determined fourth candidate answer group is stored in the candidate answer DB 126.

If, as a result of the check at step 1010, ‘n’ exceeds ‘x’, the candidate answer group determination unit 506 adjusts the number of candidate answers ‘n’ to the specific number ‘x’ based on, for example, phonetic similarity calculated by measuring the distance between phonemes at step 1012. The candidate answers adjusted as described above are set as the fourth candidate answer group at step 1014. Next, the process proceeds to step 624 of FIG. 6, and the determined fourth candidate answer group is stored in the candidate answer DB 126.

Referring back to FIG. 6, the candidate answer alignment and display block 116 aligns candidate answers within the candidate answer groups (i.e., the first to the fourth candidate answer groups), determined by the speech recognition error-answer pair DB 121, the word relationship information DB 122, the user error correction information DB 123, the domain articulation pattern DB 124, and the proper noun DB 125 and stored in the candidate answer DB 126 in accordance with the present invention, according to a specific condition and displays the aligned candidate answers at step 626.

Here, the alignment and display of candidate answers for an erroneous speech recognition word can, for example, align and display a candidate answer belonging to one or more of the determined candidate answer groups as the final candidate answer, determine and display only a candidate answer that belongs to all of the determined candidate answer groups as the final candidate answer, and align and display the determined candidate answer groups according to some specific priority.

In accordance with the present invention, there are advantages in that the disadvantages of a sound model used in a voice recognizer can be compensated for by handling errors using the speech recognition ‘error-answer’ pair DB based on the sound model, disadvantages attributable to the dependency of information on a short distance that inevitably occurs in a continuous speech voice recognizer based on n-gram can be compensated for by the word relationship information DB, disadvantages occurring as a voice recognizer is frequently used can be supplemented by the user error correction information DB, and speech recognition errors attributable to unknown vocabulary can be effectively handled in a recognizer using the domain articulation pattern DB and the proper noun DB.

Furthermore, in accordance with the present invention, a speech recognition error can be handled through various pieces of information because methods that use different DBs are combined and used in various ways. Accordingly, the probability that an answer to an error can be provided to a user can be maximized. As a result, user convenience is maximized because correct speech recognition results can be obtained even when an error occurs.

While the invention has been shown and described with respect to the exemplary embodiments, the present invention is not limited thereto. It will be understood by those skilled in the art that various changes and modifications may be made without departing from the scope of the invention as defined in the following claims.

What is claimed is:

1. A method of correcting an error in a speech recognition system, comprising:
a process of searching a speech recognition error-answer pair DB based on a sound model for a first candidate answer group for a speech recognition error;
a process of searching a word relationship information DB for a second candidate answer group for the speech recognition error;
a process of searching a user error correction information DB for a third candidate answer group for the speech recognition error;
a process of searching a domain articulation pattern DB and a proper noun DB for a fourth candidate answer group for the speech recognition error; and
a process of aligning candidate answers within each of the retrieved candidate answer groups and displaying the aligned candidate answers.

2. The method of claim 1, wherein the process of displaying the aligned candidate answers comprises displaying a candidate answer that belongs to one or more of the retrieved candidate answer groups as a final candidate answer.

3. The method of claim 1, wherein the process of displaying the aligned candidate answers comprises displaying only a candidate answer that belongs to all of the retrieved candidate answer groups as a final candidate answer.

4. The method of claim 1, wherein the process of displaying the aligned candidate answers comprises aligning the retrieved candidate answer groups according to a specific priority and displaying the aligned candidate answer groups.

5. The method of claim 1, wherein the process of searching for the first candidate answer group comprises:
a process of searching the speech recognition error-answer pair DB for a candidate answer group;
a process of calculating phonetic similarity for a corresponding erroneous speech recognition word and extracting a word having relatively high phonetic similarity, from among words included in a recognition dictionary, as a preliminary candidate answer group if, as a result of the search, a candidate answer group is not present; and
a process of setting the candidate answer group or the preliminary candidate answer group as the first candidate answer group.

6. The method of claim 5, wherein the phonetic similarity is calculated by calculating a distance between phonemes.

7. The method of claim 5, wherein the process of searching for the first candidate answer group further comprises a process of adjusting a number of candidate answers that belong to the determined first candidate answer group to a specific number if the number of candidate answers is plural.

8. The method of claim 1, wherein the process of searching for the second candidate answer group comprises:
a process of extracting remaining words other than a word recognized as the speech recognition error;
a process of extracting candidate words having a semantic correlation between words by searching the word relationship information DB based on the extracted words; and
a process of setting a word common to the extracted candidate words as the second candidate answer group.

9. The method of claim 8, wherein the process of searching for the second candidate answer group further comprises a process of adjusting a number of candidate answers that belong to the determined second candidate answer group to a specific number if the number of candidate answers is plural.

10. The method of claim 9, wherein the adjustment to the specific number is limited to a word having relatively high phonetic similarity.

11. The method of claim 1, wherein the process of searching for the third candidate answer group comprises:
a process of searching the user error correction information DB for a candidate answer group for a corresponding erroneous word;
a process of checking a number of candidate answers within the retrieved candidate answer group;
searching a server-based user error correction information DB for a preliminary candidate answer group if, as a result of the check, the number of candidate answers is less than a specific number; and
determining the candidate answer group or the candidate answer group and both the preliminary candidate answer group as the third candidate answer group.

12. The method of claim 11, wherein the process of searching for the third candidate answer group further comprises a process of adjusting a number of candidate answers that belong to the determined third candidate answer group to the specific number if the number of candidate answers is plural.

13. The method of claim 12, wherein the adjustment to the specific number is performed based on any one of phonetic similarity, information on a correlation between words, and information on a domain pattern.

14. The method of claim 11, wherein the process of searching for the preliminary candidate answer group is selectively executed when a voice recognizer is a recognizer adopting a server-client method.

15. The method of claim 1, wherein the process of searching for the fourth candidate answer group comprises:
a process of checking whether or not a corresponding erroneous word belongs to articulation to which a domain articulation pattern is applied by searching the domain articulation pattern DB;
a process of extracting a candidate answer group by searching the proper noun DB if, as a result of the check, the corresponding erroneous word belongs to the domain articulation pattern; and
a process of setting the extracted candidate answer group as the fourth candidate answer group.

16. The method of claim 15, wherein the process of searching for the fourth candidate answer group further comprises a process of adjusting a number of candidate answers that belong to the determined fourth candidate answer group to a specific number if the number of candidate answers is plural.

17. The method of claim 16, wherein the adjustment to the specific number is limited to a word having relatively high phonetic similarity.

18. An apparatus for correcting an error in a speech recognition system, comprising:
a database module for including a speech recognition error-answer pair DB based on a sound model, a word relationship information DB, a user error correction information DB, a domain articulation pattern DB, and a proper noun DB;
a speech recognition error detection block for detecting an error in speech recognition for input speech;
a first candidate answer search block for determining a first candidate answer group for a corresponding erroneous word using the speech recognition error-answer pair DB when the error in speech recognition is detected;
a second candidate answer search block for determining a second candidate answer group for the corresponding erroneous word using the word relationship information DB when the error in speech recognition is detected;
a third candidate answer search block for determining a third candidate answer group for the corresponding erroneous word using the user error correction information DB when the error in speech recognition is detected;
a fourth candidate answer search block for determining a fourth candidate answer group for the corresponding erroneous word using the domain articulation pattern DB and the proper noun DB when the error in speech recognition is detected; and
a candidate answer alignment and display block for aligning candidate answers within each of the determined candidate answer groups according to a specific condition and displaying the aligned candidate answers.

19. The apparatus of claim 18, wherein the candidate answer alignment and display block displays a candidate answer that belong to one or more of the determined candidate answer groups as a final candidate answer.

20. The apparatus of claim 18, wherein the candidate answer alignment and display block determines only a candidate answer that belongs to all of the determined candidate answer groups as a final candidate answer and displays the determined final candidate answer.
